(19) United States
(12) Patent Application Publication
(10) Pub. No.: US 2015/0212211 A1
(43) Pub. Date: Jul. 30, 2015

(54) METHODS AND SYSTEMS FOR MULTI-GNSS OPERATION

(71) Applicant: QUALCOMM Incorporated, San Diego, CA (US)

(72) Inventor: Richard Dominic WIETFELDT, San Diego, CA (US)

(73) Assignee: QUALCOMM Incorporated, San Diego, CA (US)

(21) Appl. No.: 14/163,625

(22) Filed: Jan. 24, 2014

(51) Int. Cl. G01S 19/34; G01S 19/13

(52) U.S. Cl. CPC G01S 19/34; G01S 19/13

(57) ABSTRACT

Various arrangements for using a multi-global navigation satellite system (GNSS) mobile device are presented. Embodiments may include a first GNSS unit configured to receive satellite positioning signals and create baseband data. Embodiments may include a second GNSS unit configured to receive the baseband data from the first GNSS unit. The second GNSS unit may, based on the baseband data, determine pseudorange data. The first and second GNSS units may communicate via a baseband interface configured to transfer the baseband data from the first GNSS unit to the second GNSS unit.

### BACKGROUND

Mobile devices, such as mobile phones and tablet computers, may have multiple global navigation satellite system (GNSS) receiver units that can receive positioning signals and determine position using: GPS, GLONASS, Galileo, IRNSS, Beidou, and/or other types of satellite-based positioning systems. Each of these units may be capable of determining a position of the mobile device. Due to various design choices being made when mobile devices are designed, a mobile device may have two or more GNSS units. For instance, a mobile device may have a processor having a GNSS unit on-board and a standalone GNSS unit. Conventionally, a mobile device uses only a single GNSS unit for position determination, with one or more additional GNSS units remaining unused and, possibly, wasting silicon area and/or power.

### SUMMARY

In some embodiments, a multi-global navigation satellite system (GNSS) mobile device is presented. The mobile device may include a first GNSS unit configured to receive satellite positioning signals and create baseband data. The mobile device may include a second GNSS unit. The second GNSS unit may be configured to receive the baseband data from the first GNSS unit. The second GNSS unit may be configured to, based on the baseband data, determine pseudorange data. The mobile device may also include a baseband interface configured to transfer the baseband data from the first GNSS unit to the second GNSS unit.

Embodiments of such a device may include one or more of the following features: The first GNSS unit and the second GNSS unit may be each independently capable of determining a position of the multi-GNSS mobile device. The first GNSS unit may further include a position engine configured to process pseudorange data received from the second GNSS unit and pseudorange data determined by the first GNSS unit. The position engine may be configured to use both the pseudorange data received from the second GNSS unit and pseudorange data determined by the first GNSS unit to calculate a superposition. The first GNSS unit may be further configured to calculate a position based on one or more factors using a subset of: the pseudorange data received from the first GNSS unit, and the pseudorange data determined by the first GNSS unit. The one or more factors may include at least one factor selected from noise, antenna position, and power savings. The second GNSS unit may include a multiplexer configured to receive the baseband data from the first GNSS unit. The baseband data may include analog baseband data. The second GNSS unit may include a power management module configured to individually control a supply of power to a plurality of submodules of the second GNSS unit. The first GNSS unit may be a dedicated GNSS unit and the second GNSS unit may be on-board a processor. The second GNSS unit may be further configured to detect a desense condition, wherein the second GNSS unit receives the baseband data from the first GNSS unit based on detection of the desense condition.

In some embodiments, a method for using a multi-global navigation satellite system (GNSS) device is presented. The method may include receiving, by a first GNSS unit, satellite positioning signals. The method may include creating, by the first GNSS unit, baseband data. The method may include receiving, by a second GNSS unit, the baseband data from the first GNSS unit via a baseband interface. The method may include determining, by the second GNSS unit, pseudorange data using the baseband data.

Embodiments of such a method may include one or more of the following features: The first GNSS unit and the second GNSS unit may be each independently capable of determining a position of the multi-GNSS device. The method may include receiving, by the first GNSS unit, the pseudorange data from the second GNSS unit. The method may include calculating, by the first GNSS unit, a position of the multi-GNSS device using the pseudorange data determined by the second GNSS unit and pseudorange data determined by the first GNSS unit. The method may include receiving, by the first GNSS unit, the pseudorange data from the second GNSS unit. The method may include calculating, by the first GNSS unit, a position of the multi-GNSS device using one or more factors using a subset of: the pseudorange data received from the first GNSS unit, and pseudorange data determined by the first GNSS unit. The method for using the multi-GNSS device, wherein the baseband data may include digital baseband data or analog baseband data. The method may include powering down, by the second GNSS unit, a subset of a plurality of submodules of the second GNSS unit based on receiving the baseband data from the first GNSS unit. The first GNSS unit may be a dedicated GNSS unit and the second GNSS unit is on-board a processor. The method may include detecting, by the second GNSS unit, a desense condition, wherein the second GNSS unit receives the baseband data from the first GNSS unit based on detection of the desense condition.

In some embodiments, a multi-global navigation satellite system (GNSS) apparatus is presented. The apparatus may include means for receiving, by a first GNSS unit, satellite positioning signals. The apparatus may include means for creating, by the first GNSS unit, baseband data. The apparatus may include means for receiving, by a second GNSS unit, the baseband data from the first GNSS unit. The apparatus may include means for determining, by the second GNSS unit, pseudorange data using the baseband data.

Embodiments of such an apparatus may include one or more of the following features: The first GNSS unit and the second GNSS unit may each independently be capable of determining a position of the multi-GNSS device. The apparatus may include means for receiving, by the first GNSS unit, the pseudorange data from the second GNSS unit. The apparatus may include means for calculating, by the first GNSS unit, a position of the multi-GNSS device using the pseudorange data determined by the second GNSS unit and pseudorange data determined by the first GNSS unit. The apparatus may include means for receiving, by the first GNSS unit, the pseudorange data from the second GNSS unit. The apparatus may include means for calculating, by the first GNSS unit, a position of the multi-GNSS device using one or more factors using a subset of: the pseudorange data received from the first GNSS unit, and pseudorange data determined by the first GNSS unit. The apparatus for using the multi-GNSS device, wherein the baseband data comprises analog baseband data or digital baseband data. The apparatus may include means for powering down, by the second GNSS unit, a subset of a plurality of submodules of the second GNSS unit based on receiving the baseband data from the first GNSS unit. The first GNSS unit may be a dedicated GNSS unit and the second GNSS unit may be on-board a processor. The apparatus may include means for detecting, by the second GNSS unit, a desense condition, wherein the second GNSS unit receives the baseband data from the first GNSS unit based on detection of the desense condition.

In some embodiments, a non-transitory processor-readable medium for using a multi-global navigation satellite system (GNSS) device is presented. The processor-readable instructions may be configured to cause a processor to receive baseband data from a first GNSS unit via a baseband interface. The first GNSS unit may be configured to receive satellite positioning signals and create the baseband data. The instructions may be configured to cause the processor to determine pseudorange data using the baseband data received from the first GNSS unit.

Embodiments of such a non-transitory processor-readable medium may include one or more of the following features: The processor-readable instructions may be further configured to cause the processor to power down a subset of a plurality of submodules of the second GNSS unit based on receiving the baseband data from the first GNSS unit. The processor-readable instructions may be further configured to cause the processor to detect a desense condition, wherein the baseband data is received from the first GNSS unit in response to detection of the desense condition

### BRIEF DESCRIPTION OF THE DRAWINGS

A further understanding of the nature and advantages of the detailed embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates an embodiment of a multi-GNSS unit system configured to share baseband data.

FIG. 1B illustrates another embodiment of a multi-GNSS unit system configured to share baseband data.

FIG. 2 illustrates an embodiment of a multi-GNSS unit system configured to communicate with a host processing module.

FIG. 3 illustrates various embodiments of multi-GNSS devices.

FIG. 4 illustrates an embodiment of a schematic of a GNSS unit configured to function as part of a multi-GNSS system configured to share baseband data.

FIG. 5 illustrates another embodiment of a schematic of a GNSS unit configured to function as part of a multi-GNSS system configured to share baseband data.

FIG. 6 illustrates an embodiment of an acquisition and tracking channel of a measurement engine.

FIG. 7 illustrates an embodiment of a method for sharing baseband data among multiple GNSS units.

FIG. 8 illustrates another embodiment of a method for sharing baseband data among multiple GNSS units.

FIG. 9 illustrates an embodiment of a computer system, which may be incorporated as part of a mobile device.

### DETAILED DESCRIPTION

Rather than allowing one or more additional GNSS units to remain unused, various arrangements are possible in which a mobile device's ability to perform positioning is enhanced via the use of multiple (i.e., two or more) GNSS units. The use of such one or more extra GNSS units may involve taking advantage of specific resources of the GNSS unit.

The use of multiple GNSS units can permit enhancements to the functionality of a mobile device on which the GNSS units reside. First, the use of two or more GNSS units may allow for superpositioning. Superposition refers to the ability to use measurements/calculations performed by two or more GNSS units to obtain a more accurate location of the mobile device and/or a faster location fix. These GNSS receiver units may use the same satellite-based positioning system or different satellite-based positioning systems. Also, these GNSS units may share an antenna or use different antennas. Such superpositioning can allow for a more accurate position of the mobile device to be determined and/or the position of the mobile device to be determined quicker.

Second, the use of two or more GNSS units by a same mobile device can allow for diversity. The two or more GNSS units may be alternatively powered (such that only one GNSS receiver subsystem is powered at a given time). Such an arrangement may save power when power savings is a factor to be considered. The GNSS unit that is selected for use may be based on a factor such as antenna position. For example, while a first antenna may be pointed towards the ground, a second antenna coupled with a different GNSS unit may be better positioned to receive GNSS signals. Further, correlators from one GNSS unit may be used with correlators from another GNSS unit to determine a location of the mobile device. Diversity may permit for improved handling of noise and/or coexistence desensitivity impacts resulting from concurrent radio transmissions within the device. For instance, if a first antenna of a first GNSS unit is exposed to a factor such as noise, a second antenna of a second GNSS unit may be exposed to less noise or radio coexistence desense (e.g., degradation in sensitivity due to noise), thus allowing for improved performance. For instance, one or more radios operating in the vicinity of a GNSS receiver may create noise that adversely affects the performance of the GNSS unit. If multiple GNSS receivers are present (with the GNSS units possibly be connected with different antennas) only some of the GNSS units may experience a factor such as desense or some of the GNSS units may experience desense worse that one or more other GNSS units.

A critical example of impact on GNSS is a raise in its noise floor, hence desensitization of its very sensitive receiver, which may be referred to as “desense.” Specific radios (RATs) and combinations of radios are known in advance to cause one or more types of interference to GNSS radios. In many cases, such interference is correlated to transmit power levels. In some cases, there are known transmit power levels below which a coexistence condition is known to cause immaterial or null effect to a given GNSS receiver unit. In a different implementation, GNSS receiver units may monitor their noise floor for unusual receiver anomalies, such as a raised noise floor or a specific in-band jammer. Both a priori and real-time determinations of in-band desense condition are possible implementations. A system entity known as a Coexistence Manager (CxM) may be called on to perform actions such as determining known a priori conditions, determining desense measurements in real-time, or both, and to initiate any actions to ameliorate the situation. Actions may include: moving the frequency channel, reducing a transmit power level, and/or adjusting a filter parameters. The CxM function may be located in a GNSS unit, or some other component. It can be fixed in function, or have controllable components such as including a CPU, local memory, and executing program software.

An example of a radio causing GNSS unit desense is due to emissions, typically caused by improper filtering either in the transmit aggressor or in the GNSS victim receiver. An example of a radio pair causing GNSS unit desense is due to intermodulation (IM) products, such as a 2400 MHz band WLAN signal component mixed with an 800 MHz band WWAN signal component that falls into the 1575 MHz GPS band. Many other combinations that cause desense also exist.

To lessen the effect of desense on a GNSS unit, baseband data, in either analog or digital form, may be obtained from another GNSS unit that is less affected by the desense condition. Upon the detection of one or more desense conditions, such as a noise floor of the GNSS unit exceeding a defined threshold value or interference on one or more known frequencies being generated by the device of which the GNSS unit is a part, baseband data may be obtained from a different GNSS unit (and, possibly, a different antenna). This baseband data may then be processed by the GNSS unit to determine ME and, possibly, PE data.

To manage a use of multiple GNSS units, an interface may be used to enable communication among GNSS units and, possibly, with a separate controller such as a separate processor. Such an interface may enable the various described embodiments that allow for superposition and/or diversity functions. A GNSS unit can be represented as having a measurement engine and a position engine. A measurement engine processes the timing data received via an antenna from a GNSS. Based on the received timing data, correlators can be used to determine timing information by the measurement engine. Based on the calculated timing information using the correlators, a pseudorange can be determined by the measurement engine. An interface may be present that allows for data calculated by correlators and/or other data to be exchanged between measurement engines of multiple GNSS unit systems. By exchanging correlator data between measurement engines of multiple GNSS units, the correlator data determined by multiple measurement engines of different GNSS units can be used for a single pseudorange calculation.

The pseudorange calculations may be passed to a position engine. An interface between GNSS units may permit position engines of different GNSS units to communicate with each other. Further, measurement engines of multiple GNSS units may be able to communicate with a common position engine, thus allowing a single position engine to use pseudorange calculations from multiple measurement engines. The position engine, based on the pseudorange calculations, may determine a location of the mobile device in the form of coordinates. These coordinates may be provided to an application being executed by a host processor for use as a position of the mobile device. A controller of one of the GNSS subsystem receivers, the host processor, or another separate controller may be used to control operation of the multiple GNSS unit system (e.g., controlling which submodules of each GNSS unit are turned on).

A GNSS unit refers to a GNSS receiver that is capable of receiving, either via a dedicated antenna or shared antenna, GNSS positioning signals from multiple satellites and determining its position, velocity, and/or timing, which are referred to collectively as PVT data. This PVT data may be output by the GNSS receiver module to another component or device. For instance a GNSS unit may be a separate chip on a circuit board, with the GNSS unit being in communication with another processor. In some embodiments, a GNSS unit may be part of an integrated circuit that includes a processor. As such, the PVT data may be output by the GNSS unit within the integrated circuit. In some embodiments, in addition or instead of outputting PVT data, pseudorange data is output by a GNSS unit. If a device has two (or more) GNSS units, independent of each other, the two or more GNSS units are capable of determining the position, velocity, and/or timing of the device.

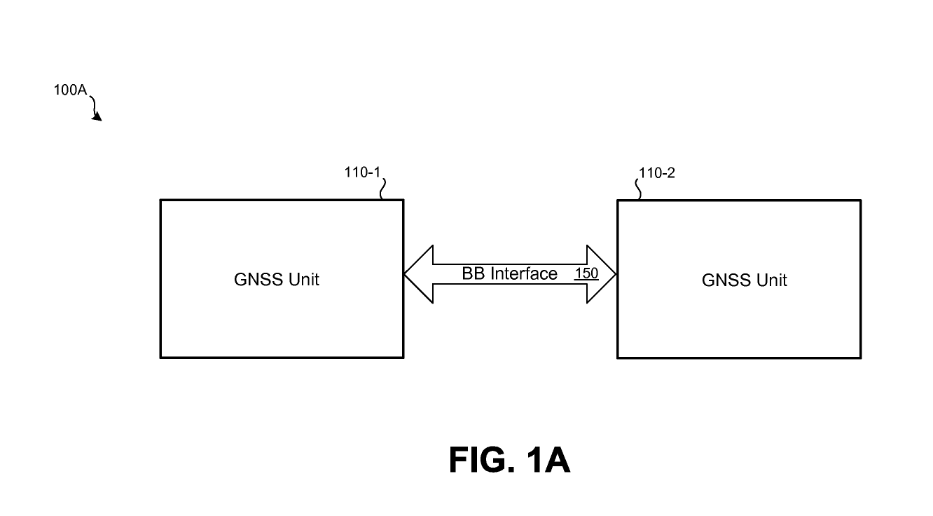

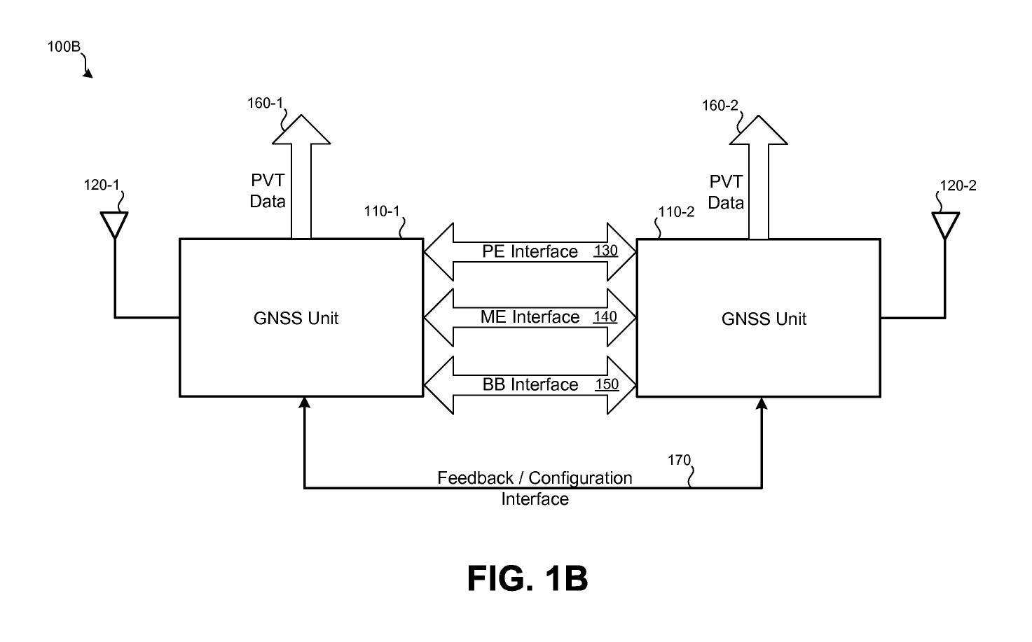

FIG. 1A illustrates an embodiment of a multi-global navigation satellite system (GNSS) system 100A configured to share baseband data. In multi-GNSS system 100A, two GNSS units are present: GNSS unit 110-1 and GNSS unit 110-2. While FIG. 1A illustrates two GNSS units 110, it should be understood that embodiments of multi-GNSS system 100A may include more than two GNSS units 110. As detailed above, each of these GNSS units is capable of processing received GNSS positioning signals and outputting calculated pseudeoranges and/or PVT data. GNSS units 110 are in communication with each other. More specifically, a baseband interface allows analog or digital data that represents received satellite positioning signals (referred to as baseband data) to be shared between GNSS units 110. In some embodiments, GNSS unit 110-1 may provide baseband data to GNSS unit 110-2. In some embodiments, GNSS unit 110-2 may provide baseband data to GNSS unit 110-1. Further, in some embodiments, GNSS units 110 may exchange baseband data.

If GNSS unit 110-1 of GNSS units 110 receives baseband (BB) data from GNSS unit 110-2, GNSS unit 110-1 may use the baseband data to determine timing information for particular satellites. These particular satellites may be part of the same or a different satellite positioning system (e.g., GPS, GLONASS, Galileo, IRNSS, and Beidou) than the satellites being used to calculate PVT/pseudorange data as GNSS unit 110-2. Once calculated, either pseudoranges or PVT data may be provided back to the GNSS unit from which the baseband data was received. As such, a GNSS unit can output baseband data and receive back calculated PVT data and/or pseudoranges.

Allowing for a common set of BB data to be processed by multiple GNSS units may have distinct advantages. For instance, if a first GNSS unit is more sensitive, has its antenna positioned more favorably to receive satellite positioning signals, has a more sensitive/powerful analog front end, and/or experiences less noise, it may be useful to use the computational resources of one or more additional GNSS units to augment the computational resources of the first GNSS unit. This arrangement may effectively increase the more sensitive/powerful GNSS unit's computational resources.

FIG. 1B illustrates another embodiment of a multi-GNSS system 100B configured to share baseband data. Multi-GNSS system 100B may represent a more detailed embodiment of multi-GNSS system 100A. In multi-GNSS system 100B, two GNSS units are present: GNSS unit 110-1 and GNSS unit 110-2. While FIG. 1B illustrates two GNSS units 110, it should be understood that embodiments of multi-GNSS system 100B may include more than two GNSS units 110. As detailed above, each of these GNSS units are capable of processing received GNSS positioning signals and outputting calculated pseudoranges and/or PVT data.

GNSS unit 110-1 is in communication with antenna 120-1. Antenna 120-1 allows GNSS unit 110-1 to receive satellite positioning signals. The satellite positioning signals may be from one or more satellite positioning systems. Antenna 120-1 may be internal or external to the device containing multi-GNSS system 100B. GNSS unit 110-1 may output PVT data 160-1 to another component in communication with GNSS unit 110-1. For instance, the other component may be a separate processor in communication with GNSS unit 110-1 or may be another component of a processor of which GNSS unit 110-1 is a part. Alternatively or in addition to PVT data 160-1, pseudorange data may be output by GNSS unit 110-1.

GNSS unit 110-2 is in communication with antenna 120-2. Antenna 120-2 allows GNSS unit 110-2 to receive satellite positioning signals. Antenna 120-2 may be internal or external to the device containing multi-GNSS system 100B. Antenna 120-2 may be physically separate from antenna 120-1. In some embodiments, a single antenna may serve as antenna 120-1 and antenna 120-2. The satellite positioning signals received by GNSS unit 110-2 may be from one or more satellite positioning systems. GNSS unit 110-2 may output PVT data 160-2 to another component in communication with GNSS unit 110-2. For instance, the other component may be a separate processor in communication with GNSS unit 110-2 or may be another component of a processor of which GNSS unit 110-2 is a part. Alternatively or in addition to PVT data 160-2, pseudorange data may be output by GNSS unit 110-2.

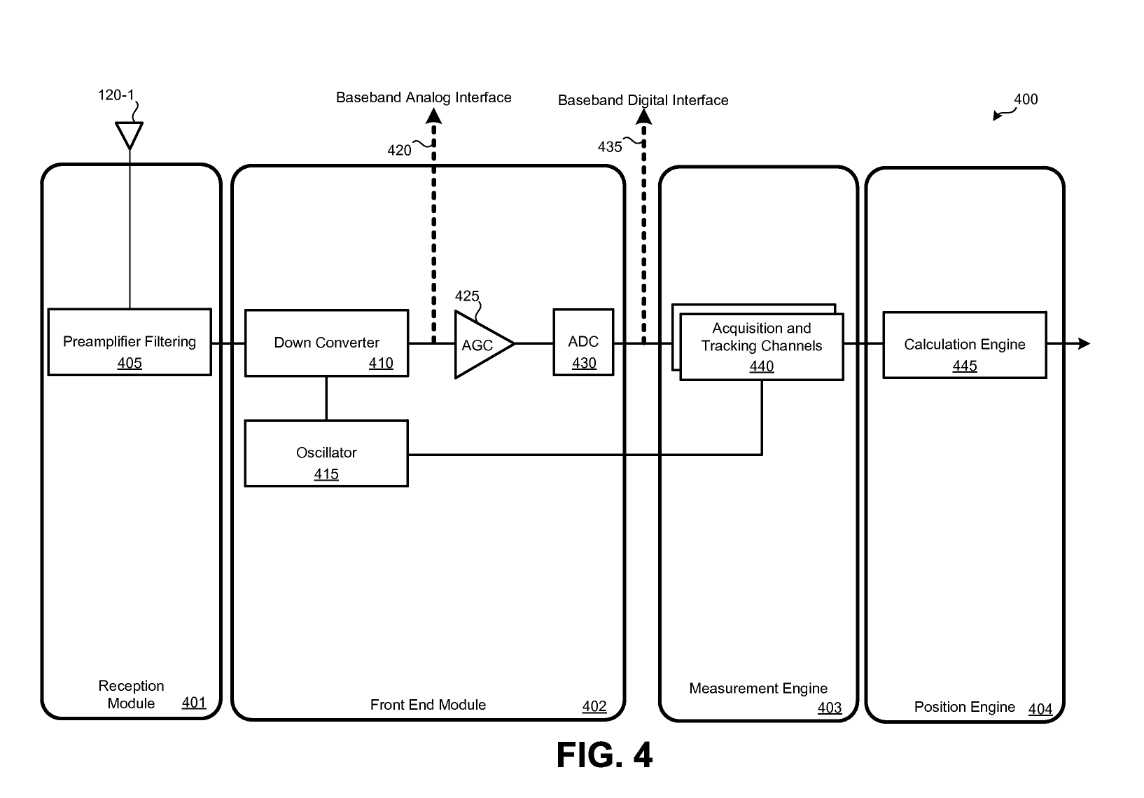

One or more physical layers of communication may exist between GNSS units 110 configured to allow for various forms of data to be exchanged between GNSS units 110. Communication interfaces may include: a baseband (BB) interface 150, a measurement engine (ME) interface 140, a position engine (PE) interface 130, and/or a feedback and/or configuration interface 170. BB interface 150 may allow for the exchange of baseband data between GNSS units 110. BB data may be characterized as being raw data received from positioning satellites that has not yet been analyzed. BB data may be analog or digital, as will be further detailed in relation to embodiments of FIG. 4. Accordingly, BB data may be understood as signals received by an antenna that have been amplified, possibly digitized, and converted to a baseband to be made suitable for further analysis by a GNSS unit. The various interfaces detailed herein may use a same or a variety of physical transmission arrangements between GNSS units and/or other processors. For instance, parallel communication lines, serial communication lines, and/or three-phase technology may be used. Referring to three-phase technology, more detail may be obtained on how such a communication arrangement may be implemented, for example, in U.S. Pat. No. 8,064,535, issued to G. Wiley, which is hereby incorporated by reference for all purposes.

ME interface 140 may permit data that has been at least partially analyzed by a GNSS unit of GNSS units 110 to be exchanged. ME data, which may be transmitted as an ME-gram, is a pseudorange that has been processed by a measurement engine of a GNSS unit 110. A “pseudorange” is a range determined by a measurement engine of a GNSS unit. A pseudorange may deviate from a true range by virtue of a difference in timing between the timing reference on the GNSS space vehicle (which is expected to be highly accurate) and the timing reference used in by the GNSS unit. The timing reference in a GNSS unit can be expected to be significantly less accurate than the timing reference signal of a GNSS satellite, for reasons such as an inexpensive quartz-based oscillator being used in the GNSS unit. Therefore, when the GNSS unit measures a range, which is the speed of light multiplied by the timing difference between the accurate time embedded via timing markers in the GNSS downlink signal from the GNSS space vehicle and the less accurate time measured by the GNSS unit, there is expected to be a range error attributed to the timing reference of GNSS unit. Due to the fact that this determined range suffers from timing errors, the measured range is referred to as a “pseudorange.”

By analyzing BB data, ME data can be calculated. ME data may be exchanged between GNSS units 110. As an example, GNSS unit 110-1 may transmit BB data via BB interface 150 to GNSS unit 110-2. Using the BB data, GNSS unit 110-2 may calculate ME data, which is transmitted to GNSS unit 110-1 via ME interface 140.

PE Interface 130 may permit PVT data to be exchanged between GNSS units 110. PE data, which may be transmitted as a PE-gram, is PVT data that has been calculated by a GNSS unit. PE data may be calculated using ME data (e.g., multiple pseudoranges). PE data may be exchanged between GNSS units 110. As an example, GNSS unit 110-1 may transmit BB data via BB interface 150 to GNSS unit 110-2. Using the BB data, GNSS unit 110-2 may calculate ME and PE data. The PE data may be transmitted to GNSS unit 110-1 via PE interface 130. In some embodiments, only one of an ME interface and PE interface are present between GNSS units 110-1.

Feedback/Configuration Interface 170 may represent one or more interfaces that allows for feedback and/or configuration data to be communicated between GNSS units 110. In some embodiments, a particular GNSS unit of GNSS units 110 can be assigned to be a master GNSS unit. The master GNSS unit may provide configuration data to other GNSS units of GNSS units 110 that indicate specific satellite positioning systems and/or specific satellites for which the slave GNSS unit should analyze received positioning signals. By way of example only, if GNSS unit 110-1 is the master GNSS unit of GNSS units 110, GNSS unit 110-1 may provide configuration data to GNSS unit 110-2 (which would be a slave GNSS unit) that indicates specific GPS satellites of which to analyze timing signals. Therefore, GNSS unit 110-1 may provide BB data via BB interface 150 to GNSS unit 110-2 and may provide configuration data via feedback/configuration interface 170 that indicates GNSS unit 110-2 is to determine ME data and/or PE data for specific GPS satellites (e.g., satellites 11-20). Such an assignment may be made because GNSS unit 110-1 is determining ME data and/or PE data for GPS satellites 1-10. Thus, for example, while GNSS units 110-1 and 110-2 may each only be able to calculate ME data for ten satellites at a given time, together, using the same BB data, GNSS units 110-1 and 110-2 together can calculate ME (or PE) data for twenty satellites. The ME or PE data calculated by slave GNSS unit 110-2 may be provided to master GNSS unit 110-1 via either PE interface 130 (if PE data) or ME interface 140 (if ME data). The ME or PE data may then be used by the master GNSS unit 110-1 to calculate refined pseudorange data and/or PVT data.

Feedback/configuration interface 170 may also permit for the exchange of feedback data. Feedback data may be used to make real-time adjustments in how data is exchanged between GNSS units 110, such as data phase, data frequency, and/or delay. At the baseband (BB) data level, feedback items may include controls of the preamplifier filter 405, down conversion oscillator 415, and automatic gain control 425 that affect the analog BB waveform or waveforms sent across the Baseband Analog Interface 420, such as of its phase, frequency, and/or delay. It may additionally include control of the analog to digital converter 430 that affects the digital BB sample stream or streams sent across the baseband digital interface 435.

At the ME and PE data levels, feedback may encompass parameters related to the processing of BB data from one GNSS receiver connected to one antenna in another GNSS receiver not connected to that antenna, or the combination or superposition of data across GNSS receiver units and possibly antennas such as calibration data. The calibration data may include the receiver noise figure for a given antenna, the antenna isolation relative to other radio transmitters in the device as related to coexistence considerations, the carrier to noise ratio for a given processing channel, and/or other parameters related to data quality.

Some or all of these detailed interfaces may use the same physical communication layer among GNSS units 110. For instance, a physical connection allowing for the serial exchange of data between GNSS units 110 may be present. In some embodiments, multiple physical connections between GNSS units 110 may be present. For instance, a dedicated communication connection may exist between GNSS units 110 for BB interface 150. Various combinations of connections between GNSS units 110 may be present that allow for the communication of BB data, ME data, PE data, configuration data, and/or feedback data.

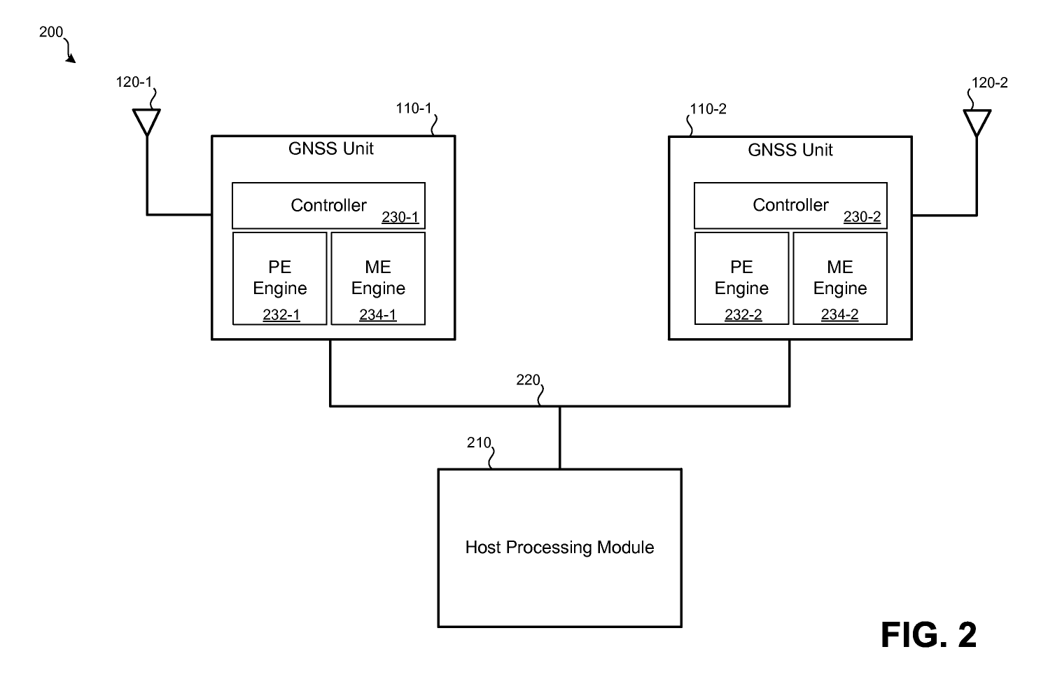

FIG. 2 illustrates an embodiment of a multi-GNSS system 200 configured to communicate with a host processing module. Multi-GNSS system 200 may represent multi-GNSS systems 100A and/or 100B of FIGS. 1A and 1B, respectively. FIG. 2 illustrates a multi-GNSS system having two GNSS units 110 and a host processing module 210.

Each GNSS module of GNSS units 110 is represented as having a controller, an ME engine, and a PE engine. For instance, referring to GNSS unit 110-1, controller 230-1, ME engine 234-1, and PE engine 232-1 are present; referring to GNSS unit 110-2, controller 230-2, ME engine 234-2, and PE engine 232-2 are present. Controllers 230 may manage communication with one or more other GNSS units of GNSS units 110 and/or may handle outputting pseudorange and/or PVT data to host processing module 210. ME engines 234 may be configured to receive BB data (either from within the same GNSS unit or from another GNSS unit) and use the BB data to calculate ME data (pseudoranges). PE engines 232 may be configured to receive ME data (either from within the same GNSS unit or from another GNSS unit) and use the ME data to calculate PE data (PVT data).

Interface 220 may permit the exchange of BB data, ME data, PE data, and/or feedback/configuration data between GNSS units 110. As detailed in reference to FIG. 1B, interface 220 may include one or more physical connections between GNSS units 110 that allow for data to be exchanged. For instance, GNSS unit 110-1 may provide BB data to GNSS unit 110-2 via interface 220. GNSS unit 110-2 may calculate ME data or PE data using the BB data. The calculated ME or PE data may be transmitted back to GNSS unit 110-1 or may be transmitted to host processing module 210.

Host processing module 210 may represent a separate processor or may represent a processor that is part of an integrated circuit containing either GNSS unit 110-1 or GNSS unit 110-2. Host processing module 210 may receive ME data or PE data from GNSS units 110. This ME data or PE data from multiple GNSS units 110 may be used to calculate a superposition of multi-GNSS system 200 by host processing module 210. In some embodiments, this ME data or PE data from multiple GNSS units 110 may be used for diversity: the ME or PE data from one of GNSS units 110 may be ignored or otherwise not used by host processing module 210. For instance, host processing module 210 may only use the ME data or PE data from a GNSS unit that has the least amount of error.

Rather than host processing module 210 using ME data or PE data from multiple GNSS units 110 for performing superposition or diversity calculations, host processing module 210 may be provided with only a single set of ME data or PE data. For instance, controller 230-1 of GNSS unit 110-1 may cause BB data to be provided to GNSS unit 110-2 via interface 220. GNSS unit 110-2 may use the provided BB data to calculate ME data and/or PE data. This calculated ME data or PE data may then be provided back to GNSS unit 110-1 via interface 220 by GNSS unit 110-2. Controller 230-1 may use ME data or PE data calculated by GNSS unit 110-1, along with the ME data or PE data received from GNSS unit 110-2, to calculate a set of ME data or PE data that is provided to host processing module 210. As such, controller 230-1 may use the ME data or PE data calculated by GNSS unit 110-1 along with the ME data or PE data received from GNSS unit 110-2 for superposition and/or diversity applications. Host processing module 210 may receive ME data or PE data, but may be unaware of whether the ME data or PE data was wholly or partially calculated by GNSS unit 110-1, GNSS unit 110-2, or both. Rather, controller 230-1 may determine the most error-free (or based on some other characteristic) ME data and provide this ME data to host processing module 210 or controller 230-1 may use this ME data to calculate PE data and provide such PE data to host processing module 210. Similarly, controller 230-1 may determine the most preferable PE data and provide this PE data to host processing module 210 or use this PE data to calculate combined PE data and provide such PE data to host processing module 210.

While FIG. 2 illustrates two GNSS units 110, it should be understood that this is a possible embodiment only. In other embodiments, more than two GNSS units may be in communication. For instance, a single master GNSS unit may be able to control multiple slave GNSS units. In some embodiments, a BB interface may be unidirectional between two GNSS units. For instance, GNSS unit 110-1 may be able to send baseband data to GNSS unit 110-2. However, GNSS unit 110-2 may not be able to send baseband data to GNSS unit 110-1. In other embodiments, a bidirectional baseband interface may exist between two GNSS units. In some embodiments, a GNSS unit may have or be in communication with an analog or digital repeater. The analog or digital repeater may be configured to provide a common set of BB data (which may be analog or digital) to two or more other GNSS units. As such, a common set of BB data may be used by three or more GNSS units to calculate any ME data and/or PE data. Such embodiments may involve the unidirectional transfer of BB data or may involve the bidirectional transfer of BB data. In some embodiments, a parallel or serial multiplexer may be used to allow baseband data from multiple GNSS units to be used by GNSS unit to calculate ME data and/or PE data. For example, in an embodiment having four GNSS units, each GNSS unit may provide baseband data to each other GNSS unit. Therefore, each GNSS unit may receive baseband data from the three other GNSS units. In some embodiments, for reasons such as to decrease the number of pins of the GNSS unit used (or the integrated circuit of which the GNSS unit is a part) devoted to such an exchange of data, a multiplexer configured to allow for the serial transfer of data among multiple GNSS units may be used. Again, such an arrangement may be for digital baseband data or analog baseband data.

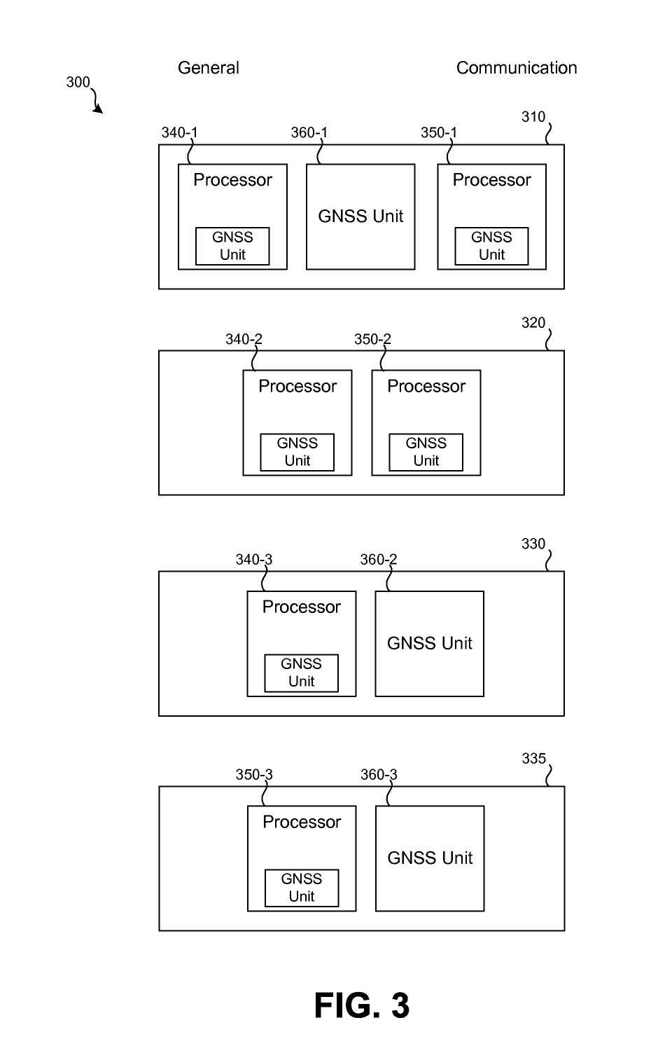

FIG. 3 illustrates various embodiments of multi-GNSS devices 300. In some situations, a manufacturer or device designer that is creating a mobile device may use one or more components that have built-in GNSS units. For instance, processor 340-1 may be a general-purpose or special-purpose processor that has a GNSS unit on board. By the mere fact that processor 340-1 has a GNSS unit on board, this does not mean that all other components that will be integrated with device 310 will be free of additional GNSS units. For instance, a dedicated GNSS unit 360-1 may be incorporated as part of device 310. Further, some other processor, such as a cellular data processor 350-1 may have a GNSS unit on-board as part of a same integrated circuit. A cellular data processor may be configured to process communication data with a cellular network (e.g., 3G, 4G LTE, and other forms of cellular networks). Therefore, device 310 may contain three GNSS units. Such GNSS units may be configured and placed into communication such that the systems of FIGS. 1A, 1B, 2, and/or 3 are present.

Device 320 illustrates another embodiment of a device that has multiple GNSS units. In device 320, general-purpose processor 340-2 has an onboard GNSS unit. Similarly, cellular data processor 350-2 has an onboard GNSS unit. Device 330 is an embodiment of a device having a general-purpose processor 340-3 but has an onboard GNSS unit and also has a dedicated GNSS unit 360-2. A dedicated GNSS unit refers to a GNSS unit that is a standalone IC (that is, not on board a processor). In device 335, cellular data processor 350-3 has an onboard GNSS unit. Similarly, dedicated GNSS unit 360-3 is present. It should be understood that other embodiments exist in which multiple GNSS units may be present. Such devices may be configured to allow for communication between GNSS units. Further, such GNSS units may be at least partially redesigned to permit for the sharing of BB data, ME data, and/or PE data.

In some embodiments, the devices of FIG. 3 may include cellular phones (e.g., smartphones). Other devices may include tablet computers, computerized vehicle systems, and/or other forms of computerized devices of which the position is desired to be determined.

FIG. 4 illustrates an embodiment of a schematic of a GNSS unit 400 configured to function as part of a multi-GNSS system configured to share baseband data. GNSS unit 400 represents a GNSS unit that is outputting BB data to another GNSS unit (or to a host processing module). GNSS unit 400 may represent a GNSS unit of FIGS. 1A, 1B, 2, and/or 3. More specifically, GNSS unit 400 may represent GNSS unit 110-1 of FIGS. 1A, 1B, and/or 2. GNSS unit 400 may be composed of multiple modules, including: reception module 401, front end module 402, measurement engine 403, and position engine 404.

Reception module 401 may include at least: antenna 120-1 and preamplifier filtering 405. Antenna 120-1 may be an antenna dedicated for use by GNSS unit 400 or may be shared among multiple GNSS units or other devices that send or receive wireless transmissions. Antenna 120-1 may be connected with preamplifier filtering 405. Preamplifier filtering 405 may, in the analog domain, function as a band-pass (or low-pass or high-pass) filter to prevent noise from reaching front end module 402. Based on the one or more satellite positioning systems from which GNSS unit 400 is configured to receive satellite positioning signals, preamplifier filtering 405 may be configured to permit such satellite positioning signals to reach front end module 402 while blocking undesired noise.

Front end module 402 may include: a down converter 410, oscillator 415, automatic gain control (AGC) 425, and analog-to-digital converter (ADC) 430. Down converter 410 may receive filtered analog satellite positioning signals from reception module 401. Down converter 410 may receive the RF signals (e.g., satellite positioning signals) and convert such signals to an intermediate frequency (IF) spectrum. In a superheterodyne configuration, this down-conversion by down converter 410 may be performed by mixing the received satellite positioning signals from reception module 401 with a signal having a frequency produced by an oscillator 415.

The IF signal output by down converter 410 may be provided to automatic gain control 425. In some embodiments, the output of down converter 410 may be output from GNSS unit 400 as analog output on baseband analog interface 420. Analog output via baseband analog interface 420 may be shared with one or more other GNSS units via a baseband interface. As such, analog output on baseband analog interface 420 may be used by one or more other GNSS receivers to calculate ME data and/or PE data.

AGC 425 may serve to adjust the average or peak signal level it outputs to a desired level. The desired level may be based on the characteristics of ADC 430. ADC 430 may output digital values based on the received analog satellite positioning system signals. As such, the output of front end module 402 may be digitized values of the received satellite positioning system signals. The output of front end module 402 may include phase (I) and quadrature (Q) components. This digital output of front end module 402 may be referred to as a (digital) baseband data output.

The output of front end module 402 may be output from GNSS unit 400 as baseband digital interface 435. Digital output via baseband digital interface 435 may be shared with one or more other GNSS units via a baseband interface. As such, the digital output of baseband digital interface 435 may be used by one or more other GNSS receivers to calculate ME data and/or PE data. While GNSS unit 400 is illustrated as having baseband analog interface 420 and baseband digital interface 435, it should be understood that in many embodiments only one form of output will be provided by front end module 402 to other GNSS units. Therefore, a multi-GNSS system may be configured to share either analog or digital baseband data among GNSS units. Regardless of whether analog or digital baseband data is output, such data would be referred to as baseband data, which is distinct from ME data (e.g., pseudoranges) and PE data. A simple distinction would be that baseband data is used to calculate ME data, which, in turn, is used to calculated PE data.

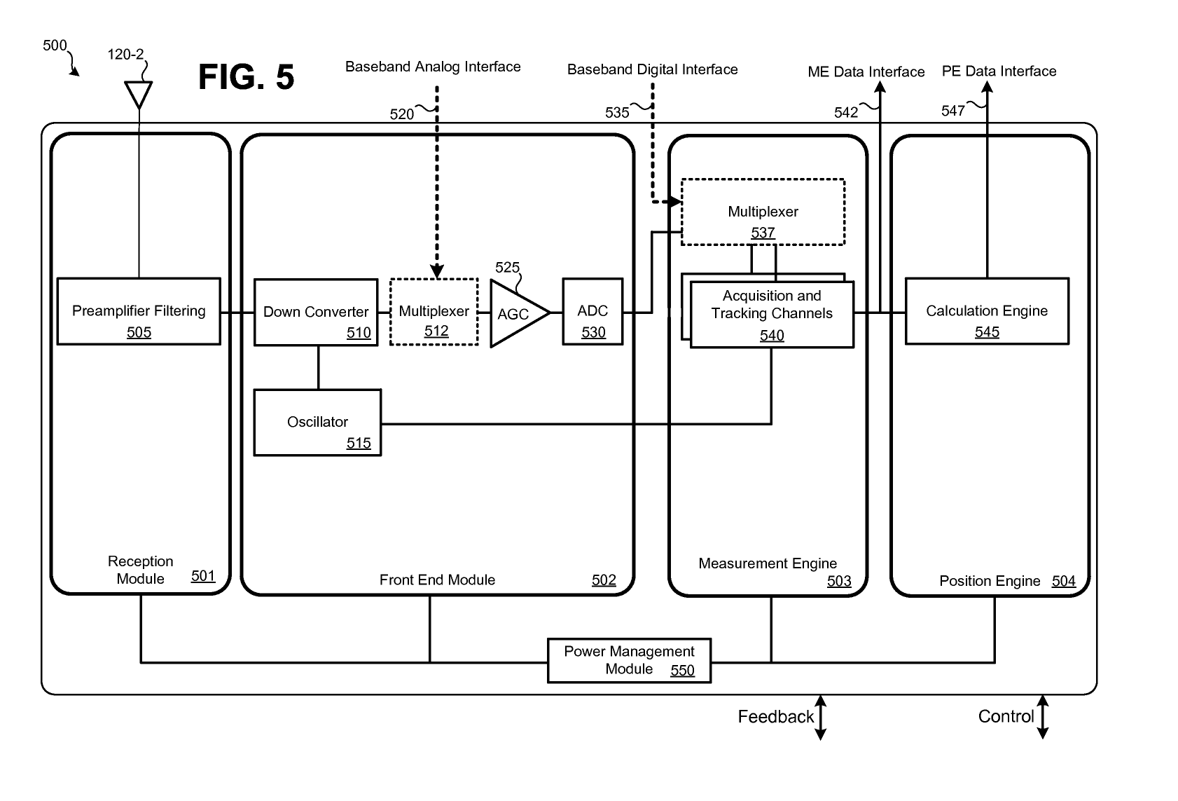

Measurement engine 403 may receive the digitized baseband data from front end module 402. Similarly, one or more other GNSS units may receive the same baseband data from front end module 402 for use by the one or more other GNSS units' measurement engines for calculated ME data. Measurement engine 403 may include multiple acquisition and tracking channels 440. Various embodiments of measurement engine 403 may be illustrated differently: for instance, acquisition and tracking channels 440 may be split into separate channels, with various channels devoted to acquisition of signals from a particular satellite and other channels devoted to tracking (after acquisition) of signals from a particular satellite. In other embodiments, a single channel may be used for both acquisition and tracking of satellite positioning signals from a particular satellite. For simplicity of drawing, GNSS unit 400 is illustrated as having combined acquisition and tracking channels. It should be understood that in some embodiments, multiple acquisition and tracking channels, such as ten, are present within measurement engine 403. Further detail regarding acquisition and tracking channels 440 is provided in reference to FIG. 5. In short, it should be understood that by having a baseband interface among multiple GNSS units, the computational ability of acquisition and tracking channels across multiple GNSS units may be used. As an example, acquisition and tracking channels 440 of measurement engine 403 may only be capable of acquiring and tracking satellite positioning signals from ten satellites concurrently (e.g., ten channels are present). By outputting baseband data via either baseband analog interface 420 or baseband digital interface 435 to another GNSS unit, additional acquisition and tracking channels of the other GNSS units may be used for tracking additional (or the same) satellites.

Acquisition and tracking channels 440 may receive the digitized intermediate frequency signal from ADC 430 of front end module 402. Each channel of acquisition and tracking channels 440 may be configured to acquire and track a satellite positioning signal from a single satellite at a given time. An acquisition engine of acquisition and tracking channels 440 may search for a large number of delay/frequency hypotheses using a large number of correlators until a signal match is acquired. Once acquired, signals of the satellite may be tracked. Each channel of acquisition and tracking channels 440 may be considered independent and may track different signals from different satellites autonomously. Each channel may output pseudoranges for the particular satellite for which it is analyzing received positioning signals. Which satellite a particular channel tracks may be based on configuration data provided by a controller of GNSS unit 400 or from another GNSS unit. Different satellites may use different frequencies for transmitting satellite positioning signals. Acquisition and tracking channels 440 may determine code delay and carrier phase measurements which are used to produce pseudorange measurements, carrier phase delay measurements, and Doppler frequency measurements. Each channel of acquisition and tracking channels 440 includes at least two lock loops: a delay locked loop (DLL) and the phase lock loop (PLL) which are used to track the code delay and carrier phase delays, respectively. Measurement engine 403 may also be configured to calculate a carrier to noise ratio, which may be used to determine the expected accuracy of ME data produced by acquisition and tracking channels 440.

The output of measurement engine 403 may be referred to as ME data, which can include pseudoranges. The output ME data may be a combination of results obtained from multiple channels of acquisition and tracking channels 440. In some embodiments, pseudoranges are provided to a separate processing device, such as a host processing module. In other embodiments, such pseudoranges may be used by GNSS unit 400 in combination with pseudoranges from another GNSS module to calculate a composite set of ME data or to calculate a set of PE data, which may then be provided to a separate processing device, such as a host processing module. Such a combination of ME data may be referred to as a superposition function. Rather than combining ME data, a set of ME data from a particular GNSS unit may be selected. For instance such selection may occur based on the carrier-to-noise ratio associated with the ME data. Such use of ME data may be referred to as a diversity function.

ME data output by acquisition and tracking channels 440 may be received by position engine 404. Position engine 404 may contain calculation engine 445. Calculation engine 445 may use the ME data produced by measurement engine 403 to calculate PE data, also referred to as PVT data. This PVT data may then be output to another processing device, such as a host processing module. In some embodiments, a controller of GNSS unit 400 may perform superposition or diversity functions using the PE data calculated by calculation engine 445 in combination with PE data calculated by one or more other GNSS units.

FIG. 5 illustrates another embodiment of a schematic of a GNSS unit configured to function as part of a multi-GNSS system configured to share baseband data. GNSS unit 500 represents a GNSS unit that is receiving BB data from another GNSS unit. GNSS unit 500 may represent a GNSS unit of FIGS. 1A, 1B, and 2, or 3. More specifically, GNSS unit 500 may represent GNSS unit 110-2 of FIGS. 1A, 1B, and/or 2. GNSS unit 500, like GNSS unit 400, may be composed of multiple modules, including: reception module 501, front end module 502, measurement engine 503, and position engine 504.

Reception module 501 may function similarly to reception module 401 and include at least: antenna 120-2 and preamplifier filtering 505. Antenna 120-1 may be an antenna dedicated to use by GNSS unit 500 or may be shared among multiple GNSS units or other devices that send or receive wireless transmissions. Antenna 120-2 represents antenna 120-1 in some embodiments. Antenna 120-1 may be connected with preamplifier filtering 505. Preamplifier filtering 505 may, in the analog domain, function as a band-pass (or low-pass or high-pass) filter to prevent noise from reaching front end module 502 as detailed in relation to preamplifier filtering 405.

Front end module 502 may include at least: a down converter 510, oscillator 515, automatic gain control (AGC) 525, and analog-to-digital converter (ADC) 530. Down converter 510 and oscillator 515 may function similarly to previously-detailed down converter 410 and oscillator 415 of FIG. 4.

Multiplexer 512 may be configured to receive analog baseband data from multiple sources. Multiplexer 512 may be configured to receive analog input via baseband analog interface 520 and IF baseband data from down converter 510. Therefore, multiplexer 512, if receiving analog baseband data via baseband analog interface 520 from some other GNSS unit, such as GNSS unit 400, may be able to output analog baseband data to AGC 525, wherein the baseband data was received either via reception module 501 or is analog baseband data from another GNSS unit.

The baseband IF signal, which may be from baseband analog interface 520 (which corresponds to baseband analog interface 420) and/or from down converter 510, may be provided to automatic gain control (AGC) 525. Therefore, if the baseband IF data is received via baseband analog interface 520, the remainder of processing performed by GNSS unit 500 on satellite positioning signals may be performed on a baseband IF signal created by a separate GNSS receiver.

AGC 525 may serve to adjust the average or peak signal level it outputs to a desired level. The desired level may be based on the characteristics of ADC 530. ADC 530 may output digital values based on the received analog satellite positioning system signals. As such, the output of front end module 502 may be digitized values of the received satellite positioning system signals. The output of front end module 502 may include phase (I) and quadrature (Q) components. This digital output of front end module 502 may be referred to as a digital baseband output.

In some embodiments, the outputted ADC 530 is fed to measurement engine 503. Therefore, if multiplexer 512 has baseband analog interface 520 selected, the digitized baseband data output by ADC 530 corresponds to the baseband data received via baseband analog interface 520. In some embodiments, rather than receiving baseband analog data via baseband analog interface 520, GNSS unit 500 receives baseband data via baseband digital interface 535. Baseband digital interface 535 may correspond to baseband digital interface 435 of FIG. 4. As such, rather than receiving analog baseband data, digital baseband data may be received. If such a baseband digital interface is used, multiplexer 537 may be present as part of measurement engine 503 (possibly in lieu of multiplexer 512). Multiplexer 537 may determine whether the digitized output of ADC 530 or the baseband data received via baseband digital interface 535 is provided to acquisition and tracking channels 540. If GNSS unit 500 is to be used to perform calculations on baseband data calculated by a separate GNSS receiver, such as GNSS unit 400, GNSS unit 500 may be configured such that multiplexer 537 routes baseband data from baseband digital interface 535 to acquisition and tracking channels 540.

Measurement engine 503 may use the digitized baseband data from baseband digital interface 535. Measurement engine 503 may include multiple acquisition and tracking channels 540. It should be understood that varying numbers of acquisition and tracking channels, such as ten, can be present within measurement engine 503.

Acquisition and tracking channels 540 may receive the digitized intermediate frequency signal from ADC 530 of front end module 502 or from baseband digital interface 535. Each channel of acquisition and tracking channels 540 may be configured to acquire and track a satellite positioning signal from a single satellite at a given time. An acquisition engine of acquisition and tracking channels 540 may search for a large number of delay/frequency hypotheses using a large number of correlators until a signal is acquired. Once acquired, the signals of the satellite may be tracked. Each channel of acquisition and tracking channels 540 may be considered independent and may track different signals from different satellites autonomously. Each channel may output pseudoranges for the particular satellite for which it is analyzing received positioning signals. Which satellite a particular channel tracks may be based on configuration data provided by a controller of GNSS unit 400 or from another GNSS unit. Different satellites may use different frequencies for transmitting satellite positioning signals. Acquisition and tracking channels 440 may determine delay and carrier phase measurements which are used to produce pseudorange measurements, carrier phase delay measurements, and Doppler frequency measurements. Each channel of acquisition and tracking channels 540 includes at least two lock loops: a delay locked loop (DLL) and the phase lock loop (PLL) which are used to track the code delays and carrier phase delays, respectively. Measurement engine 503 may also be configured to calculate a carrier to noise (C/N) ratio, which may be used to determine the expected accuracy of ME data produced by acquisition and tracking channels 540.

The output of measurement engine 503 may be referred to as ME data, which can include pseudoranges. The output ME data may be a combination of results obtained from multiple channels of acquisition and tracking channels 540. The ME data calculated by measurement engine 503 may be output as ME data 542 to another device. ME data 542 may be output to another GNSS unit, such as GNSS unit 400, from which baseband data was received via either baseband analog interface 520 or baseband digital interface 535. Therefore, GNSS unit 400 may output baseband data and receive ME data 542 calculated based on the baseband data in response.

ME data output by acquisition and tracking channels 540 may be received by position engine 504. Position engine 504 may contain calculation engine 545. Calculation engine 545 may use the ME data produced by measurement engine 503 to calculate PE data, also referred to as PVT data. This PVT data may then be output as PE data 547 to another processing device, such as a host processing module. PE data 547 may be output to another GNSS unit, such as GNSS unit 400, from which baseband data was received via either baseband analog interface 520 or baseband digital interface 535. Therefore, GNSS unit 400 may output baseband data and receive PE data 547 calculated based on the baseband data in response.

GNSS unit 400 has been described as outputting baseband data in either an analog or digital format; GNSS unit 500 has been described as receiving baseband data in either an analog or digital format. Therefore, together, GNSS unit 400 and GNSS unit 500 may represent, for example, the multi-GNSS system of FIGS. 1A, 1B, and/or 2. GNSS unit 400 has been described as solely having the ability to output baseband data. Conversely, GNSS unit 500 is described as solely having the ability to receive baseband data. It should be understood that these are merely two possible embodiments. In some embodiments, each GNSS unit may be configured to receive and transmit baseband data. Whether a particular GNSS unit is configured to receive, transmit, or both receive and transmit baseband data, may be based on how the multi-GNSS system of which the GNSS unit is a part is configured. For instance, if a first GNSS unit is determined to be more sensitive in a particular situation, such as based on where each GNSS unit's antenna is positioned, the first GNSS unit may be used to obtain baseband data. However, if the position of the multi-GNSS system changes, a second GNSS unit may become more sensitive. Therefore, baseband data may be collected by the second GNSS unit and provided to other GNSS units for processing.

GNSS unit 500 may contain power management module 550. Power management module 550 may be configured to selectively be able to provide power to individual modules of GNSS unit 500. As such, only a subset of the modules of GNSS unit 500 may be powered on at a given time. For example, if GNSS unit 500 receives baseband data via baseband digital interface 535, data produced by reception module 501 and front end module 502 may be unused. As such, power management module 550 may be configured such that reception module 501 and front end module 502 are not powered in such a contingency. For simplicity, such a power management module was not illustrated as part of GNSS unit 400. However, such a power management module may also be able to control whether power is supplied to individual modules of GNSS unit 400.

GNSS unit 500 may be configured to provide and/or receive feedback with another GNSS unit, such as GNSS unit 400. This feedback may encompass parameters related to the combination or superposition of data across GNSS receivers such as calibration data. The calibration data may include receiver noise figure for a given antenna, carrier to noise ratio for a given processing channel, and other parameters related to data quality.

Additionally or alternatively, GNSS unit 500 may be configured to provide and/or receive control data with another GNSS unit, such as GNSS unit 400. For instance control data may indicate which satellites should be tracked by acquisition and tracking channels 540. As an example, if GNSS unit 400 provides baseband data to GNSS unit 500 via either baseband analog interface 520 or baseband digital interface 535, GNSS unit 400 may also specify via control data which satellites acquisition and tracking channels 540 of measurement engine 503 should be used to acquire and track. Control data may also indicate whether ME data 542 and/or PE data 547 should be provided back to GNSS unit 400 or to some other processing device. Rather than GNSS unit 500 being the slave (that is, the GNSS unit that is controlled by another GNSS unit), GNSS unit 500 may be the master GNSS unit that controls what types of data are output by other GNSS units and/or what satellites (of which satellite positioning system) are tracked by measurement engines of other GNSS units.

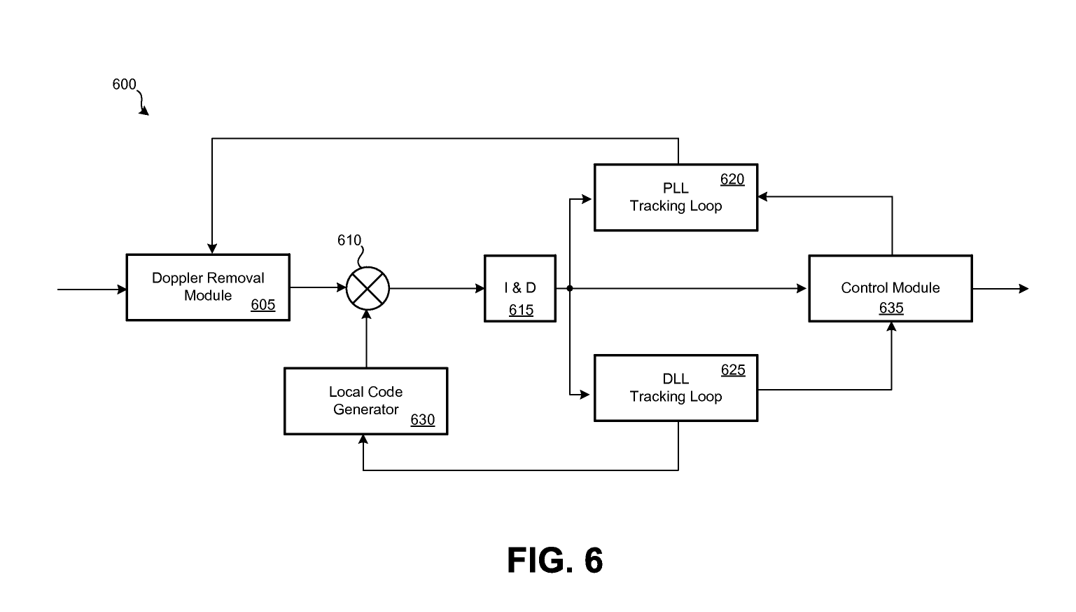

FIG. 6 illustrates an embodiment of an acquisition and tracking channel 600 of a measurement engine. As such, acquisition and tracking channel 600 may represent an acquisition and tracking channel of acquisition and tracking channels 540 of FIG. 5 or an acquisition and tracking channel of acquisition and tracking channels 440 of FIG. 4. Each component of acquisition and tracking channel 600 may be implemented using hardware as part of a GNSS unit.

Doppler removal module 605 may receive digital baseband data from either a front end module of the GNSS unit or from another GNSS unit via a baseband digital interface. Doppler removal module 605 can rotate the incoming signal by the estimated amount of carrier phase to remove the incoming Doppler frequency in CDMA-based GNSS systems, such as GPS and Galileo. In FDMA systems, such as GLONASS, all satellites transmit the same ranging (PRN) code, but each satellite is assigned with a dedicated center frequency and frequency band. I In such cases, the Doppler removal module may include the estimated Doppler frequency added to the centre frequency shift, which is specific to that satellite.

Correlator 610 may be used to correlate or “multiply” a pseudorandom binary sequence (PRN) code replica with the output of Doppler removal module 605. The code replica is generated by local code generator 630 based on the current hypothesis of code delay and Doppler frequency. While a single correlator 610 is illustrated as being present, it should be understood that a large number of correlators may be present per channel (e.g., hundreds, thousands). Correlators may be reassigned between channels. Therefore, there may typically be hundreds or thousands of correlators (similar to correlators 610), which each correlator connected to the output of Doppler Removal Module 605. Further, there may be an I&D elemental circuit for each correlator 610, which are grouped into I&D module 615 for graphical simplicity.

Integrate and Dump (I&D) 615 accumulates the output of correlator 610 and the other correlators over a time interval designed for each specific application and “dumps” or latches the accumulator outputs such that integration can proceed. While I&D 615 is illustrated as a single entity, it may be implemented in a pair that produce in-phase (I) and quadrature (Q) correlation components.

PLL tracking loop 620 and DLL tracking loop 625 are used to follow and update the parameters to be estimated at the receiver: the code delay via DLL tracking loop 625 that feeds local code generator 630, and the carrier phase via PLL tracking loop 620 that feeds the Doppler removal module 605. A new estimation of these parameters is provided on a periodic basis such as every “integrate and dump” interval to update Doppler removal module 605 and local code generator 630. While FIG. 6 illustrates PLL Tracking Loop 620 to follow the phase of the incoming carrier signal, an alternate design may employ a Frequency Locked Loop (FLL) to follow the Doppler frequency of the incoming signal. Tracking loop design may be of importance on a GNSS unit as it may dictate the ability to correctly track a received signal, hence influencing the accuracy of the pseudorange and/or position determination.

Control module 635 may serve as the monitor and control point of the DLL/PLL and/or FLL loops, and which may transition measurement engine operation from acquisition mode (in which the search across code delay and Doppler frequency yields a 2D correlation signal peak) to tracking mode (in which the estimates of the code delay and Doppler frequency or carrier phase are continuously refined and after which the navigation message is ultimately decoded). Control module 635 may also transition operations back to acquisition mode if the correlation signal is lost due to increased noise, GNSS signal obstructions, and/or other factors.

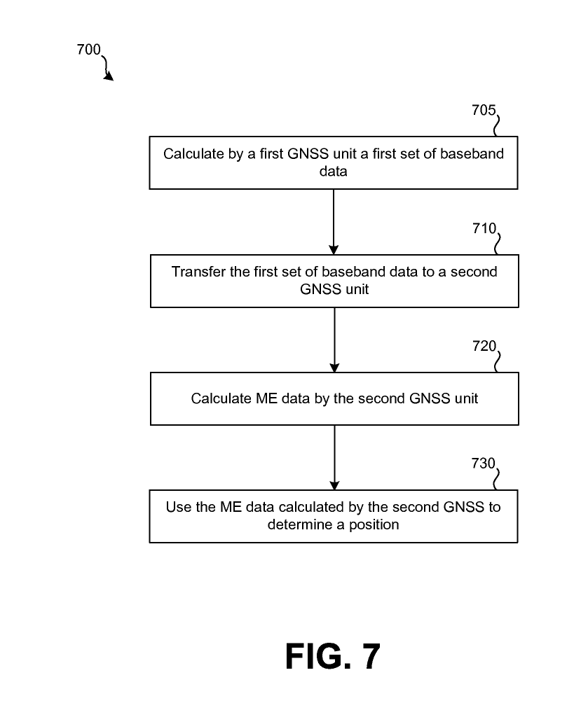

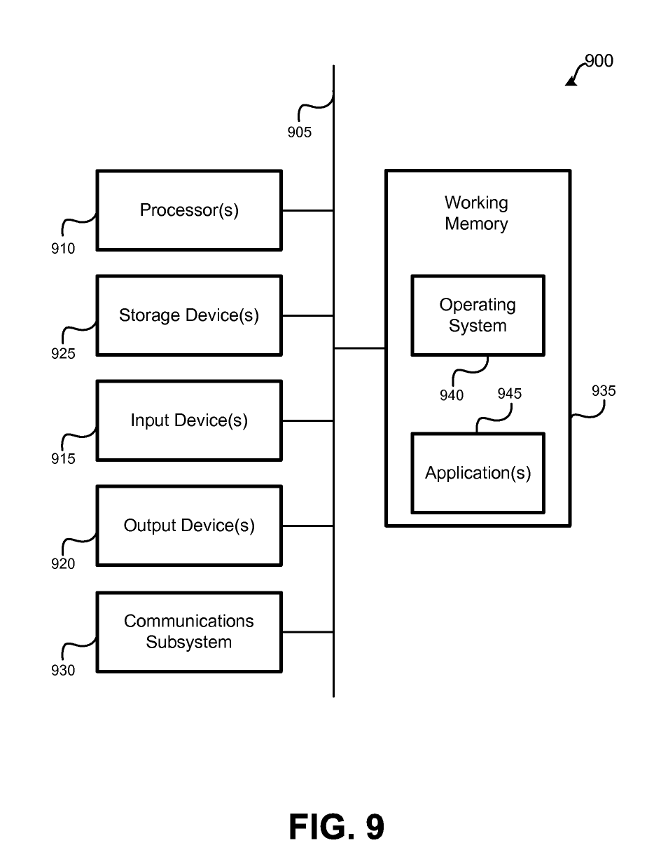

Various methods may be performed using the systems detailed in FIGS. 1A, 1B, 2, 3, 4, 5, and 6. FIG. 7 illustrates an embodiment of a method 700 for sharing baseband data among multiple GNSS units. Method 700 may be performed using the systems of FIGS. 1A-6. For instance, referring to FIG. 1A, the sharing of baseband data may occur via BB interface 150 between GNSS unit 110-1 and GNSS unit 110-2. Each GNSS unit involved in performing method 700 may be individually capable of determining ME and/or PE data from received satellite position system signals. Blocks of method 700 may be performed using the components of FIGS. 1A-6. Further, computerized components, such as those detailed in relation to FIG. 9 may be used for performing method 700.

At block 705, a first GNSS unit may determine a first set of baseband data. For example, referring to FIG. 4, GNSS unit 400 may receive satellite position system (SPS) signals via antenna 120-1 and may use a bandpass filter to extract the analog SPS signals from background noise. Further, a down converter may be used in conjunction with a local oscillator to convert the SPS signals to an intermediate frequency. Such SPS signals may then be considered to be analog baseband data. Means for performing block 705 generally include a reception module and front end module. More specifically, means for performing block 705 include an antenna, preamplifier filtering components, a down converter, and an oscillator.

At block 710, the first set of baseband data may be transmitted to a second GNSS unit. Like the first GNSS unit, the second GNSS unit is capable of determining ME and/or PE data from received SPS signals. At block 710, the baseband data may be transmitted from the first GNSS unit to the second GNSS unit using an analog baseband interface, such as baseband analog interface 420 of FIG. 4. In some embodiments, the baseband data is transmitted as digital baseband data rather than analog baseband data. In such embodiments, at least an ADC of the first GNSS unit is used to convert the analog baseband data to digital baseband data. The baseband data may then be transmitted to the second GNSS unit via a digital baseband interface. Means for performing block 710 include a front end module and a baseband interface. The baseband interface may be configured to transmit analog or digital baseband data. Specific components that may be involved in performing block 710 include an automatic gain control, an ADC, and an electrical connection between the first and second GNSS units to serve as the digital or analog interface.

At block 720, the second GNSS unit may receive the analog or digital baseband data via either an analog or digital baseband interface and may use the received baseband data to calculate ME data and/or PE data. Referring to FIG. 5, analog BB data may be received via baseband analog interface 520; digital BB data may be received via baseband digital interface 535. If analog baseband data is received, at least an ADC may be used by a front end module of the second GNSS unit to create digital BB data. Digital BB data may be processed by one or more acquisition and/or tracking channels 540 of the second GNSS unit to create ME data (e.g., pseudorange data). In some embodiments, the second GNSS unit uses the created ME data to create PE data. Means for performing block 720 include a front end module, a baseband interface, and a measurement engine. The baseband interface may be configured to transmit analog or digital baseband data. Specific components that may be involved in performing block 720 include an automatic gain control, an ADC, a multiplexer, an electrical connection between the first and second GNSS units to serve as the digital or analog interface, and one or more acquisition and/or tracking channels, which may be part of a measurement engine. If PE data is to be created, means for performing block 720 may also include a position engine.

At block 730, the ME data calculated by the second GNSS unit is used to determine a position. Referring, for example, to FIG. 2, the ME data calculated by the second GNSS unit may be used by the first GNSS unit or by a separate processing module to calculate a position. The ME data calculated by the second GNSS unit may be used in conjunction with the ME data calculated by the first GNSS unit to determine a position (e.g., of the mobile device of which the first and GNSS unit are a part). In some embodiments, rather than the ME data of the second GNSS unit being transmitted to the first GNSS unit or processor, the second GNSS unit may receive ME data from the first GNSS unit. In such embodiments, the second GNSS unit may then be used to calculate a position. While the above description of block 730 focuses on the exchange of ME data (e.g., pseudoranges), block 730 may be performed using PE data instead. The transfer of ME or PE data may be accomplished via an ME data interface or a PE data interface, respectively. Whether ME or PE data is used, such a position calculation of block 730 may allow for a superposition analysis or diversity analysis to be performed. For a superposition analysis, ME/PE data from both the first GNSS unit and the second GNSS unit is used, likely to obtain a more accurate position. For a diversity analysis, ME/PE data from a particular GNSS unit of the first and second GNSS unit may be used to determine a position. Selection of which data is used may be based on which set of ME or PE data is associated with a lower amount of error or other measurements, such as a signal strength measurement or signal-to-noise (SNR) measurement. Means for performing block 730 include a measurement engine, a position engine, an ME data interface, and/or a PE data interface. Specific components that may be involved in performing block 730 include one or more acquisition and tracking channels of a measurement engine, a calculation engine of a position engine, and/or an ME or PE data interface.

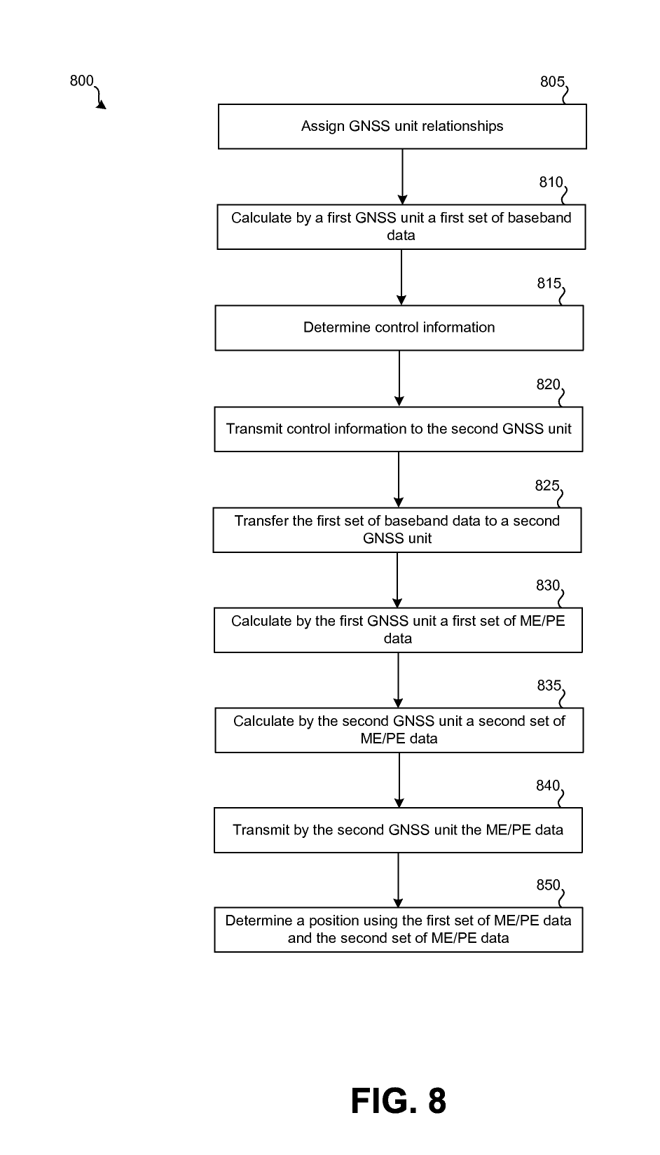

FIG. 8 illustrates another embodiment of a method 800 for sharing baseband data among multiple GNSS units. Method 800 may be performed using the systems of FIGS. 1A-6. For instance, referring to FIG. 1B, the sharing of baseband data may occur via BB interface 150 between GNSS unit 110-1 and GNSS unit 110-2, with control data being exchanged between GNSS units via feedback/control interface 170. Each GNSS unit involved in performing method 800 may be individually capable of determining ME and/or PE data from received satellite position system signals. Blocks of method 800 may be performed using the components of FIGS. 1A-6. Further, computerized components, such as those detailed in relation to FIG. 9, may be used for performing method 700. Method 800 may represent a more detailed embodiment of method 700. While method 800 details how two GNSS units may be used to determine a position by exchanging BB data, it should be understood that three or more GNSS units may also be used for determining position by exchanging BB data.

At block 805, GNSS unit relationships may be assigned. For instance, a particular GNSS unit may be designated a master GNSS (which issues commands to one or more other GNSS units), and one or more GNSS units may be designated as slaves (which process received commands). In some embodiments, a separate processor or processing module may handle relationship assignments. The master GNSS may measure SPS signals and create the BB data. In some embodiments, a slave GNSS may be assigned to measure SPS signals and create the baseband data. In some embodiments, multiple GNSS units may measure SPS signals and create BB data. Means for performing block 805 may include two or more GNSS units. A controller of a GNSS unit may designate the relationships. In some embodiments, a separate processor may be used to designate the relationships.

At block 810, a first GNSS unit (which may be a master or slave) may determine a first set of baseband data. For example, referring to FIG. 4, GNSS unit 400 may receive SPS signals via antenna 120-1 and may use a bandpass filter to extract the analog SPS signals from background noise. Further, a down converter may be used in conjunction with a local oscillator (LO) to convert the SPS signals to an intermediate frequency. Such SPS signals may then be labeled as analog baseband data. Means for performing block 705 generally include a reception module and front end module. More specifically, means for performing block 810 include an antenna, preamplifier filtering components, a down converter, and an oscillator. The first GNSS unit may measure the SPS signals and create the BB data, based on the assignment of block 805.

At block 815, control information may be determined by a master GNSS unit, which may be the first GNSS unit. The control information may instruct one or more other GNSS units which satellite positioning system should be used to determine ME/PE data and/or which satellites of a satellite positioning system should be tracked for SPS signals. As such, if a set of BB data contains raw measurements for twenty SPS satellites, the master GNSS unit may assign a slave GNSS unit to acquire and track a first subset of the satellites of the satellite positioning system while another GNSS unit, such as the master GNSS unit, tracks a second subset (which may or may not overlap the first subset). At block 820, such control information may be transmitted to one or more GNSS units, which includes the second GNSS unit. Means for performing blocks 815 and 820 include a master GNSS unit or a separate processor. In some embodiments, a controller of a GNSS unit performs blocks 815 and 820. A control interface, which may be separate or combined with a BB interface, may be used for transmitting control data between GNSS units.

At block 825, the second GNSS unit, which may be a slave, may receive the analog or digital baseband data via either an analog or digital baseband interface and may use the received baseband data to calculate ME data and/or PE data. Referring to FIG. 5, analog BB data may be received via baseband analog interface 520; digital BB data may be received via baseband digital interface 535. Means for performing block 825 include a front end module, a baseband interface, and a measurement engine. The baseband interface may be configured to transmit analog or digital baseband data. Specific components that may be involved in performing block 825 include an electrical connection between the first and second GNSS units to serve as the digital or analog interface, and one or more multiplexers, which may be part of a measurement engine.

If analog baseband data is transmitted from the first GNSS unit to the second GNSS unit, at least an ADC may be used by a front end module of the first and second GNSS unit to create digital BB data. Digital BB data may be processed by one or more acquisition and/or tracking channels of the first and second GNSS unit to create ME data (e.g., pseudorange data) at blocks 830 and 835. If digital baseband data is transmitted from the first GNSS unit to the second GNSS unit, the second GNSS unit may not need to use functionality of a front end module of the second GNSS unit. In some embodiments, a power management module may be configured to power down modules of a GNSS receiver that are unused. For instance, if digital BB data is received by the second GNSS receiver, a front end module and a reception module may be powered down. If analog BB data is received by the second GNSS receiver, the reception module may be powered down. If PE data is not to be created, a position engine may be powered down. Power management module 550, which may be part of a controller of a GNSS unit, may respond to instructions contained in control data received from a master GNSS unit.

While both the first and second GNSS units may compute ME data based on at least some of the same BB data, the first and second GNSS units may acquire and track different satellites from the same BB data. As such, the ME data is at least partially based on a common set of BB data, but may pertain to at least some different satellites of the same or a different satellite positioning system. In some embodiments, at block 835 and 840, only ME data (e.g., pseudoranges) are created. In other embodiments, each GNSS unit may create PE data (e.g., PVT data). Means for performing blocks 830 and 835 include two or more GNSS units, each having tracking and acquisition channels, which are parts of measurement engines. Such tracking and acquisition channels may each resemble the tracking and acquisition channels detailed in relation to FIG. 6. If PE data is to be created, each GNSS unit may use a position engine to create PE data.

At block 840, the second GNSS unit may transmit its calculated ME/PE data. Such ME/PE data may be transmitted to the master GNSS unit or to some other processing device, such as a host processing module. If transmitted to a host processing module, the first GNSS unit may also transmit its calculated ME/PE data to the host processing module. Means for performing block 840 include an ME or PE data interface that allows the exchange of ME or PE data.

At block 850, the ME or PE data calculated by the second GNSS unit is used to determine a position. Referring, for example, to FIG. 2, the ME data calculated by the second GNSS unit may be used by the first GNSS unit, which may be a master GNSS unit, or by a separate processing module to calculate a position. The ME or PE data calculated by the second GNSS unit may be used in conjunction with the ME or PE data calculated by the first GNSS unit to determine a position (e.g., of the mobile device of which the first and GNSS unit are a part). In some embodiments, rather than the ME data of the second GNSS unit being transmitted to the first GNSS unit or processor, the second GNSS unit may receive ME data or PE from the first GNSS unit, which may be the master GNSS. In such embodiments, the second GNSS unit may then use its position engine to calculate a position. The transfer of ME or PE data may be accomplished via an ME data interface or a PE data interface. Whether ME or PE data is used, such a position calculation of block 850 may allow for a superposition analysis or diversity analysis to be performed. For a superposition analysis, ME/PE data from both the first GNSS unit and the second GNSS unit is used for a position calculation, likely to obtain a faster solution (that is, the position is based on an increased number of correlators resulting in less processing time) or a more accurate position (that is, the position is based on SPS signals from more satellites; thus the position can be expected to be more accurate). For a diversity analysis, ME/PE data from a particular GNSS unit of the first and second GNSS units may be used to determine a position. (Alternatively, if more than two GNSS units are used to produce ME/PE data, ME/PE data may be used from a subset of the GNSS units that calculated ME/PE data based on at least some common BB data.) Selection of which data is used may be based on which set of ME or PE data is associated with a lower amount of error or other measurements, such as a signal strength measurement or signal-to-noise (SNR) measurement. In some embodiments, the orientation of the device containing the multi-GNSS system may be used to select which ME/PE data is used (e.g., which antenna is facing the sky). In some embodiments, touch sensors may be used to determine which antenna(s) are not being touched by an external object (e.g., a finger or hand). Means for performing block 730 include a measurement engine, a position engine, an ME data interface, and/or a PE data interface. Specific components that may be involved in performing block 730 include one or more acquisition and tracking channels of a measurement engine, a calculation engine of a position engine, and/or an ME or PE data interface.

FIG. 9 illustrates an embodiment of a computer system, which may be incorporated as part of a mobile device. A computer system as illustrated in FIG. 9 may be incorporated as part of the previously described computerized devices, such as a mobile device that has two GNSS units on-board. FIG. 9 provides a schematic illustration of one embodiment of a computer system 900 that can perform various blocks of the methods provided by various embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, video decoders, and/or the like); one or more input devices 915, which can include without limitation a mouse, a keyboard, remote control, and/or the like; and one or more output devices 920, which can include without limitation a display device, a printer, and/or the like. One or more of processors 910 may be a GNSS unit on-board, as detailed in relation to FIG. 3. Other GNSS units may be standalone (i.e., not on-board a same integrated circuit as a processor). Further one or more of processors 910 may function as a host processing module. For instance, host processing module 210 may perform superposition or diversity functions based on ME or PE data received from two or more GNSS units.

The computer system 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 900 might also include a communications subsystem 930, which can include without limitation a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. The communications subsystem 930 may permit data to be exchanged with a network (such as the network described below, to name one example), other computer systems, and/or any other devices described herein. In many embodiments, the computer system 900 will further comprise a working memory 935, which can include a RAM or ROM device, as described above.

The computer system 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 925 described above. In some cases, the storage medium might be incorporated within a computer system, such as computer system 900. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 900) to perform methods in accordance with various embodiments of the invention. According to a set of embodiments, some or all of the procedures of such methods are performed by the computer system 900 in response to processor 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the non-transitory storage device(s) 925. Merely by way of example, execution of the sequences of instructions contained in the working memory 935 might cause the processor(s) 910 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 900, various computer-readable media might be involved in providing instructions/code to processor(s) 910 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 925. Volatile media include, without limitation, dynamic memory, such as the working memory 935.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900.

The communications subsystem 930 (and/or components thereof) generally will receive signals, and the bus 905 then might carry the signals (and/or the data, instructions, etc. carried by the signals) to the working memory 935, from which the processor(s) 910 retrieves and executes the instructions. The instructions received by the working memory 935 may optionally be stored on a non-transitory storage device 925 either before or after execution by the processor(s) 910.

It should further be understood that the components of computer system 900 can be distributed across a network. For example, some processing may be performed in one location using a first processor while other processing may be performed by another processor remote from the first processor. Other components of computer system 900 may be similarly distributed. As such, computer system 900 may be interpreted as a distributed computing system that performs processing in multiple locations. In some instances, computer system 900 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional blocks not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A multi-global navigation satellite system (GNSS) mobile device, comprising:
a first GNSS unit configured to receive satellite positioning signals and create baseband data;
a second GNSS unit configured to:
receive the baseband data from the first GNSS unit; and
based on the baseband data, determine pseudorange data; and
a baseband interface configured to transfer the baseband data from the first GNSS unit to the second GNSS unit.

2. The multi-GNSS mobile device of claim 1, wherein the first GNSS unit and the second GNSS unit are each independently capable of determining a position of the multi-GNSS mobile device.

3. The multi-GNSS mobile device of claim 1, wherein the first GNSS unit further comprises:
a position engine configured to process pseudorange data received from the second GNSS unit and pseudorange data determined by the first GNSS unit.

4. The multi-GNSS mobile device of claim 3, wherein the position engine is configured to use both the pseudorange data received from the second GNSS unit and pseudorange data determined by the first GNSS unit to calculate a superposition.

5. The multi-GNSS mobile device of claim 1, wherein the first GNSS unit is further configured to calculate a position, based on one or more factors, using a subset of:
the pseudorange data received from the first GNSS unit, and
the pseudorange data determined by the first GNSS unit.

6. The multi-GNSS mobile device of claim 5, wherein the one or more factors includes at least one factor selected from the group consisting of: noise, antenna position, and power savings.

7. The multi-GNSS mobile device of claim 1, wherein the second GNSS unit further comprises:
a multiplexer configured to receive the baseband data from the first GNSS unit.

8. The multi-GNSS mobile device of claim 1, wherein the baseband data comprises analog baseband data.

9. The multi-GNSS mobile device of claim 1, wherein the second GNSS unit comprises a power management module configured to individually control a supply of power to a plurality of submodules of the second GNSS unit.

10. The multi-GNSS mobile device of claim 1, wherein the first GNSS unit is a dedicated GNSS unit and the second GNSS unit is on-board a processor.

11. The multi-GNSS mobile device of claim 1, wherein the second GNSS unit is further configured to detect a desense condition, wherein the second GNSS unit receives the baseband data from the first GNSS unit based on detection of the desense condition.

12. A method for using a multi-global navigation satellite system (GNSS) device, the method comprising:
receiving, by a first GNSS unit, satellite positioning signals;
creating, by the first GNSS unit, baseband data;
receiving, by a second GNSS unit, the baseband data from the first GNSS unit via a baseband interface; and
determining, by the second GNSS unit, pseudorange data using the baseband data.

13. The method for using the multi-GNSS device of claim 12, wherein the first GNSS unit and the second GNSS unit are each independently capable of determining a position of the multi-GNSS device.

14. The method for using the multi-GNSS device of claim 12, the method further comprising:
receiving, by the first GNSS unit, the pseudorange data from the second GNSS unit; and
calculating, by the first GNSS unit, a position of the multi-GNSS device using the pseudorange data determined by the second GNSS unit and pseudorange data determined by the first GNSS unit.

15. The method for using the multi-GNSS device of claim 12, further comprising:
receiving, by the first GNSS unit, the pseudorange data from the second GNSS unit; and
calculating, by the first GNSS unit, a position of the multi-GNSS device using one or more factors using a subset of:
the pseudorange data received from the first GNSS unit, and
pseudorange data determined by the first GNSS unit.

16. The method for using the multi-GNSS device of claim 12, wherein the baseband data comprises digital baseband data.

17. The method for using the multi-GNSS device of claim 12, wherein the baseband data comprises analog baseband data.

18. The method for using the multi-GNSS device of claim 12, further comprising:
powering down, by the second GNSS unit, a subset of a plurality of submodules of the second GNSS unit based on receiving the baseband data from the first GNSS unit.

19. The method for using the multi-GNSS device of claim 12, wherein the first GNSS unit is a dedicated GNSS unit and the second GNSS unit is on-board a processor.

20. The method for using the multi-GNSS device of claim 12, further comprising:
detecting, by the second GNSS unit, a desense condition, wherein the second GNSS unit receives the baseband data from the first GNSS unit based on detection of the desense condition.

21. A multi-global navigation satellite system (GNSS) apparatus, the multi-GNSS apparatus comprising:
means for receiving, by a first GNSS unit, satellite positioning signals;
means for creating, by the first GNSS unit, baseband data;
means for receiving, by a second GNSS unit, the baseband data from the first GNSS unit; and
means for determining, by the second GNSS unit, pseudorange data using the baseband data.

22. The multi-GNSS apparatus of claim 21, wherein the first GNSS unit and the second GNSS unit are each independently capable of determining a position of the multi-GNSS apparatus.

23. The multi-GNSS apparatus of claim 21, the multi-GNSS apparatus further comprising:
means for receiving, by the first GNSS unit, the pseudorange data from the second GNSS unit; and
means for calculating, by the first GNSS unit, a position of the multi-GNSS apparatus using the pseudorange data determined by the second GNSS unit and pseudorange data determined by the first GNSS unit.

24. The multi-GNSS apparatus of claim 21, further comprising:
means for receiving, by the first GNSS unit, the pseudorange data from the second GNSS unit; and
means for calculating, by the first GNSS unit, a position of the multi-GNSS apparatus using one or more factors using a subset of:
the pseudorange data received from the first GNSS unit, and
pseudorange data determined by the first GNSS unit.

25. The multi-GNSS apparatus of claim 21, wherein the baseband data comprises analog baseband data.

26. The multi-GNSS apparatus of claim 21, further comprising:
means for powering down, by the second GNSS unit, a subset of a plurality of submodules of the second GNSS unit based on receiving the baseband data from the first GNSS unit.

27. The multi-GNSS apparatus of claim 21, wherein the first GNSS unit is a dedicated GNSS unit and the second GNSS unit is on-board a processor.

28. The multi-GNSS apparatus of claim 21, further comprising:
means for detecting, by the second GNSS unit, a desense condition, wherein the second GNSS unit receives the baseband data from the first GNSS unit based on detection of the desense condition.

29. A non-transitory processor-readable medium for using a multi-global navigation satellite system (GNSS) device, comprising processor-readable instructions configured to cause a processor to:
receive baseband data from a first GNSS unit via a baseband interface, wherein:
the first GNSS unit is configured to receive satellite positioning signals and create the baseband data; and
determine pseudorange data using the baseband data received from the first GNSS unit.

30. The non-transitory processor-readable medium for using the multi-GNSS device of claim 29, wherein the processor-readable instructions are further configured to cause the processor to:
detect a desense condition, wherein the baseband data is received from the first GNSS unit in response to detection of the desense condition.
